(19) United States
(12) Patent Application Publication
(10) Pub. No.: US 2017/0121634 A1
(43) Pub. Date: May 4, 2017

(54) CANDLE WITH SHIMMERING PROPERTIES

(71) Applicant: Snugz/USA, Inc., West Jordan, UT (US)

(72) Inventor: Dzung Quoc Le, Salt Lake City, UT (US)

(21) Appl. No.: 14/931,067

(22) Filed: Nov. 3, 2015

Related U.S. Application Data
(60) Provisional application No. 62/249,795, filed on Nov. 2, 2015.

(51) Int. Cl. C11C 5/00; F23D 3/16

(52) U.S. Cl. CPC C11C 5/004; F23D 3/16

(57) ABSTRACT

A candle with shimmering properties has (i) wax; and (ii) light reflective particles dispersed throughout the wax, in the form of a candle base mixture, such that upon lighting the candle base mixture with a flame, at least a portion of the candle base mixture melts from a solid state to a liquid state, forming a pool of molten liquid in which the liquid moves. The light reflective particles highlight the movement of the liquid, such that the movement of the liquid is visible to an observer. A wick may be mounted within the candle base mixture and a container may contain the candle base mixture. A fragrance and/or dye are optional ingredients of the candle.

### RELATED APPLICATION

This patent application is a non-provisional patent application which claims priority to and the benefit of U.S. provisional patent application Ser. No. 62/249,795, filed on Nov. 2, 2015 entitled “Candle with Shimmering Properties,” which is incorporated herein in its entirety by reference.

### BACKGROUND OF THE INVENTION

1. The Field of the Invention

This invention is in the field of candles.

2. The Relevant Technology

Candles provide a function of providing light, as well as a function of providing atmosphere and scent to a room or other space. When burning, candles provide heat and light. These features of candles are often appreciated and witnessed by those near a burning candle. However, typical candles also provide a dynamic that is unappreciated or underappreciated by the typical candle observer.

### SUMMARY OF THE INVENTION

In addition to providing light and warmth, the burning of candles causes a liquid motion at the central wick portion of candles that is often unappreciated or underappreciated by the typical candle observer because the liquid motion is typically not seen by the observer. As solid candle wax adjacent the wick melts, a pool of molten, liquid wax forms adjacent the wick. The pool typically appears to at least certain observers to be a stagnant, unmoving pool of melted, liquid wax. However, the liquid wax, in the melted pool is actually moving through the process of convection.

Heated liquid on the surface of the molten pool of liquid wax moves away from the heated, lit wick, in a dynamic circulating motion that is interesting and fascinating to watch. The movement of the molten, liquid wax away from the flame on the wick, however, is often not visible because the motion of the translucent molten liquid wax is often not discernible.

The applicant's invention enables the motion of the liquid within a candle to be readily witnessed by an observer. By mixing candle wax with light reflective particles, the motion of the molten wax is discernible by viewing the motion of the light reflective particles dispersed throughout the molten wax. The light reflective particles reflect the light from the flame on the wick, highlighting the movement of the molten liquid at the center of the candle near the wick in a similar manner that a leaf within a stream highlights the movement and direction of the flowing water.

The shimmering properties of the candle of the present invention thus enable the candle observer to witness the interesting, mesmerizing movement of the surface liquid flowing in a continuous, circulating process away from the lit wick of the candle, similar to viewing molten lava flowing from a volcano, resulting in candles that are more dynamic and interesting to a candle user. Thus, the shimmering properties of the candle of the present invention enable an observer to see the movement of the liquid flow within the candle, providing another fascinating aspect to the burning of candles.

The introduction of particles with light reflective properties may also slow the burning of the candle by interacting with the wick and/or wax to slow the burning process, extending the life of a candle by minutes or hours by causing the candle to burn more slowly. Essentially, the light reflective particles interfere somewhat with the flow of wax through the wick, thereby slowing the burning process.

One embodiment of the present invention comprises a candle with shimmering properties, comprising: (A) a candle base mixture comprising: (i) wax; and (ii) light reflective particles dispersed throughout the wax; (B) a wick mounted within the candle base mixture; and (C) a container for containing the candle base mixture, such that upon lighting the candle with a flame, at least a portion of the candle base mixture melts from a solid state to a liquid state, forming a pool of molten liquid in which the liquid moves, and wherein the light reflective particles highlight the movement of the liquid, such that the movement of the liquid is visible to an observer. In one embodiment, the candle base mixture further comprises a fragrance and/or a dye.

In one embodiment, the candle base mixture is comprised of: (i) wax in an amount of about 98.99 percent to about 80 percent by weight; (ii) light reflective particles in an amount of about 0.01 percent to about 10 percent by weight; and (iii) fragrance in an amount of about 1 percent to about 12 percent by weight. In another embodiment, the candle base mixture is comprised of: (i) wax in an amount of about 91.5 percent by weight; (ii) light reflective particles in an amount of about 0.5 percent by weight; and (iii) fragrance in an amount of about 8 percent by weight.

In one possible embodiment of the present invention, the light reflective particles are glitter that is comprised of an opaque pigment. For example, the glitter may be comprised of an oxide (e.g., a colorant), a reflecting agent, and an anti-caking agent. At least one component of the glitter or other light reflective particles are reflective, so as to reflect light produced from the flame, or elsewhere (e.g., room lighting, etc.). For example, in one embodiment, the glitter is comprised of titanium dioxide, calcium aluminum borosilicate, and silica. The glitter may further comprise tin oxide. Such light reflective particles are in the form of opaque glitter powder pigments. As a result of the ingredients of the candle base mixture, the candle has a long burning life.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates an unlit candle 10 of the present invention, while FIG. 1B illustrates the candle 10 being lit by a source of fire in the form of a match.

FIG. 2A illustrates a prior art candle that does not have a light reflective particles of the present invention and therefore may have a larger burning flame which consumes candle wax more quickly than the present invention.

FIG. 2B illustrates a candle 10 of the present invention which may have a smaller burning flame, consuming candle wax less quickly because of the light reflective particles dispersed within the wax, as taught by the present invention.

FIGS. 3A-B illustrate an example of the moving surface of the candle 10 being visible because of the light reflective particles of the present invention, and in FIG. 3B highlighting the surface wax moving outwardly away from the heated wick and amassing adjacent and about the wick, as the candle 10 continues to burn.

FIG. 4A illustrate an unlit candle 10, while FIG. 4B illustrates in cross sectional view the motion of the molten wax at the top and center of the candle near the wick, the surface movement of the candle being visible because of the light reflective particles 26 of the present invention, highlighting the surface wax moving outwardly away from the heated wick.

FIG. 4C illustrates the amassing of light reflective particles adjacent and about the wick as the candle 10 continues to burn more and more, which may slow the burning speed of the wax through the wick.

FIG. 5 illustrates the process of melting and viewing wax of the present invention which is enabled through the use of light reflective particles.

FIGS. 6-9 are photographs of a candle of the present invention, demonstrating the flow of liquid that is visible in a burning candle, the visibility of the flow being possible through the use of reflective particles of the present invention.

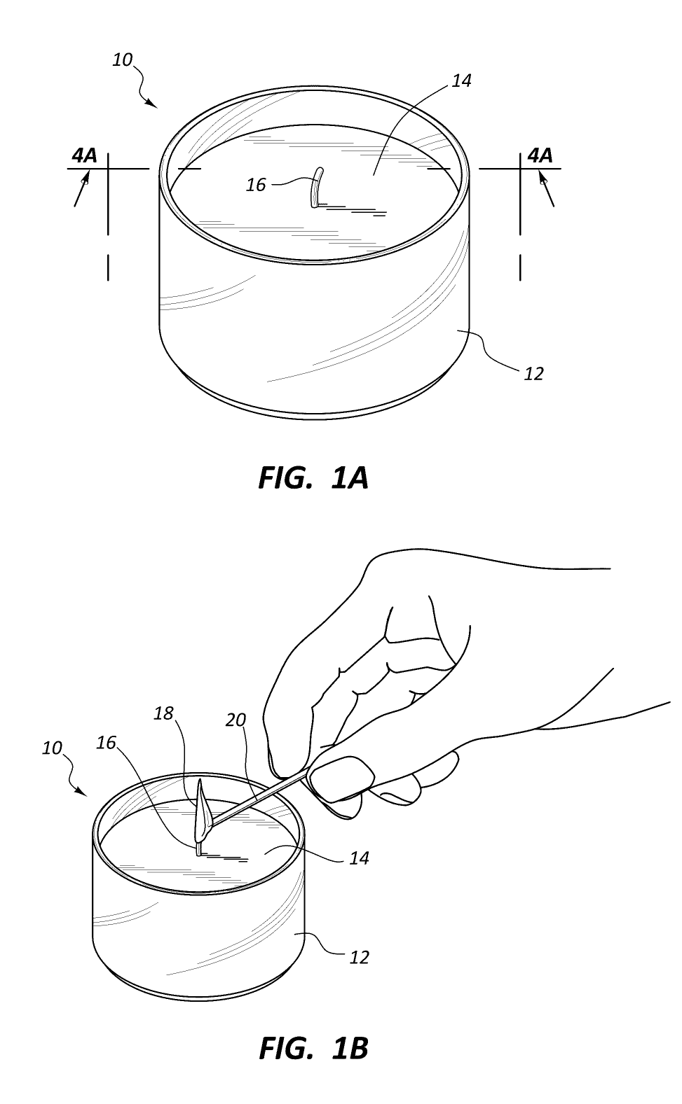

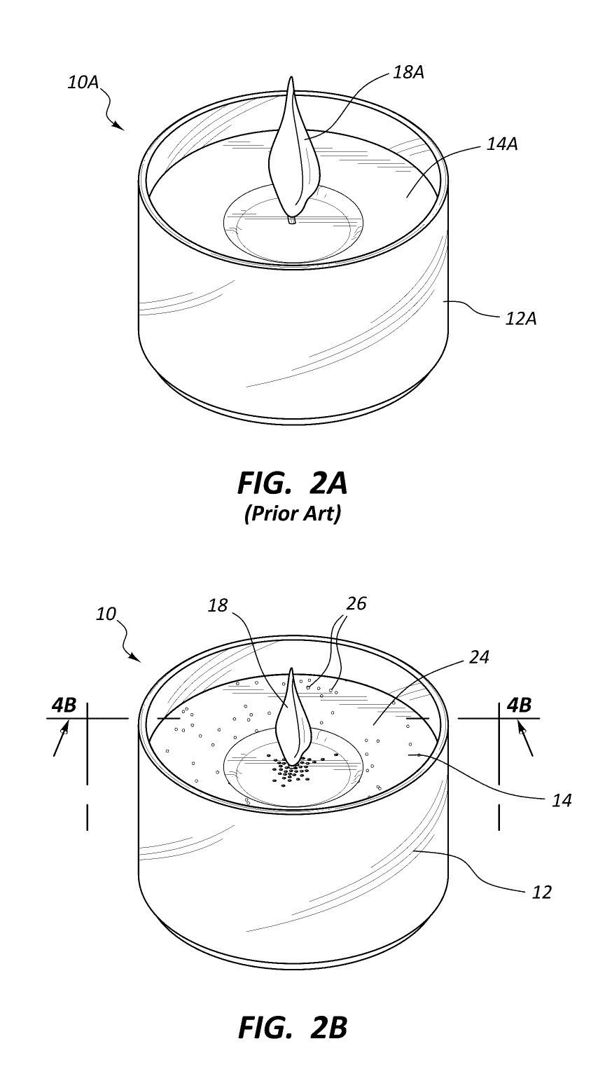

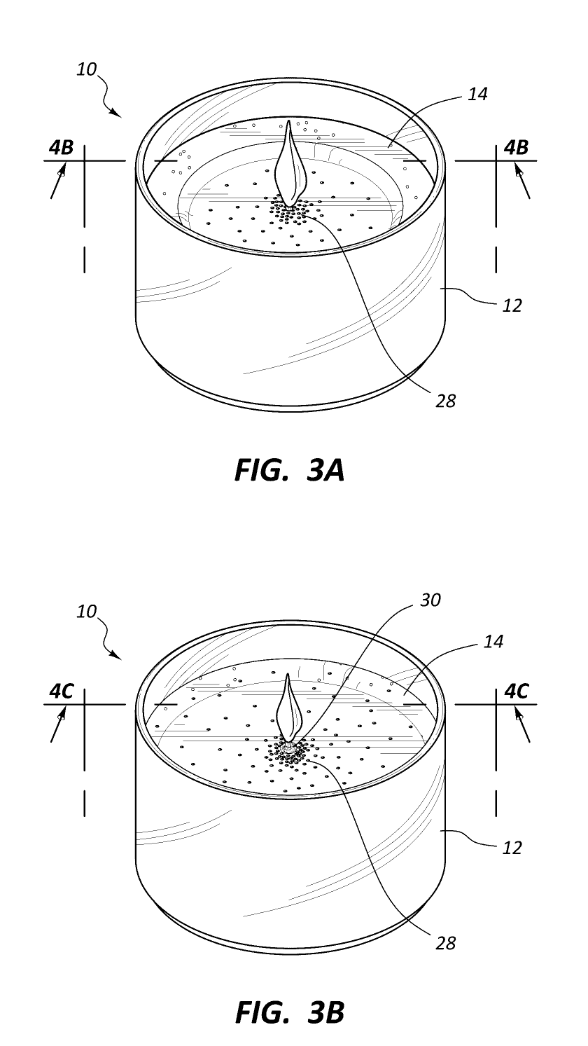

The U.S. provisional patent application Ser. No. 62/249,795, filed on Nov. 2, 2015 entitled “Candle with Shimmering Properties,” including Appendix “A” and Appendix “B”, discloses additional features, formulas and examples and methods of the present invention, and is incorporated herein by reference.

### DETAILED DESCRIPTION OF THE PREFERRED EMBODIMENTS

A candle 10 with shimmering properties of the present invention may comprise: (A) a container 12; and (B) a candle base mixture 14 comprising (i) wax 24; and (ii) light reflective particles 26 dispersed throughout the wax 24, in the form of a candle base mixture, such that upon lighting the candle base mixture with a flame 18, at least a portion of the candle base mixture melts from a solid state to a liquid state, forming a pool of molten liquid 28 in which the liquid moves as illustrated in the figures, and wherein the light reflective particles highlight the movement of the liquid, such that the movement of the liquid is visible to an observer; and (C) a wick 16 mounted within the candle base mixture. Container 12 may be any type of container that contains candle base mixture 14, such as a metal or plastic or glass container, for example. In one embodiment, the candle base mixture further comprises a fragrance and/or a dye.

In an embodiment, no container 12 may be provided. For example, the wick and size (e.g., diameter) of the candle base mixture may be such that a pool of molten wax is contained within a perimeter of unmelted solid wax base 14, so that no separate container is actually needed. In another embodiment, no wick may be provided, e.g., the candle (e.g., with a container) may be placed on a candle warmer, which melts the wax of the candle base mixture. Under such conditions, the heat generated by the candle warmer may be such as to cause similar convective flow of the molten wax, with light reflective particles entrained therein.

In one embodiment, the candle base mixture 14 is comprised of: (i) wax 24 in an amount of about 98.99 percent to about 80 percent by weight; (ii) light reflective particles 26 in an amount of about 0.01 percent to about 10 percent by weight; and (iii) fragrance in an amount of about 1 percent to about 12 percent by weight. In another embodiment, the candle base mixture is comprised of: (i) wax in an amount of about 91.5 percent by weight; (ii) light reflective particles in an amount of about 0.5 percent by weight; and (iii) fragrance in an amount of about 8 percent by weight.

In one possible embodiment of the present invention, the light reflective particles 26 are glitter that is comprised of an opaque pigment. For example, the glitter may be comprised of an oxide, a reflecting agent, and an anti-caking agent. For example, in one embodiment, the glitter is comprised of titanium dioxide, calcium aluminum borosilicate, and silica. The glitter may further comprise tin oxide. Such light reflective particles may be in the form of opaque glitter powder pigments. Such glitter may not be combustible, so as to remain, even after the wax has been consumed.

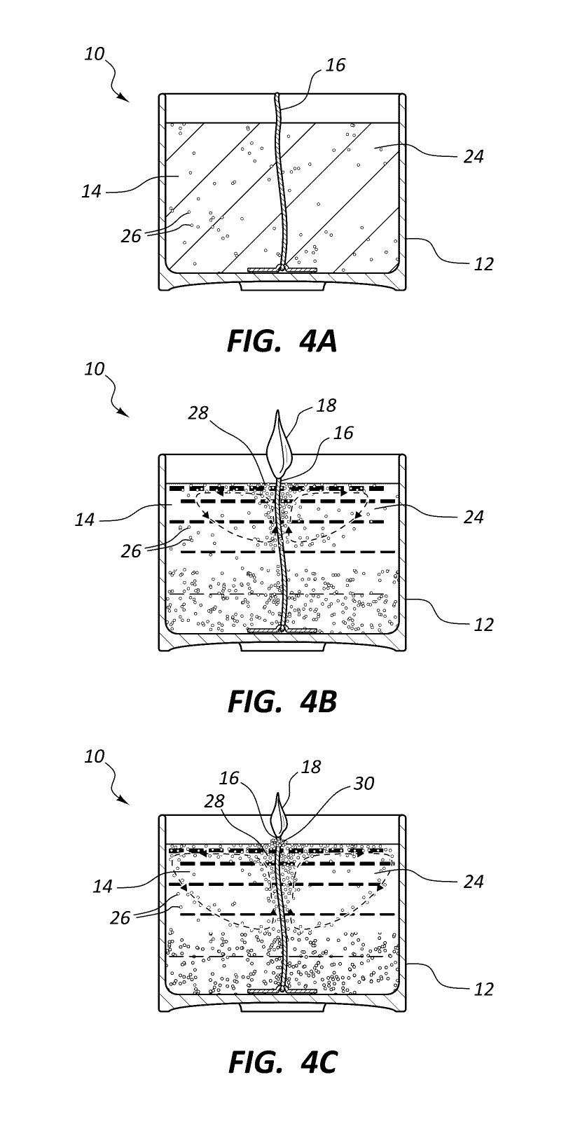

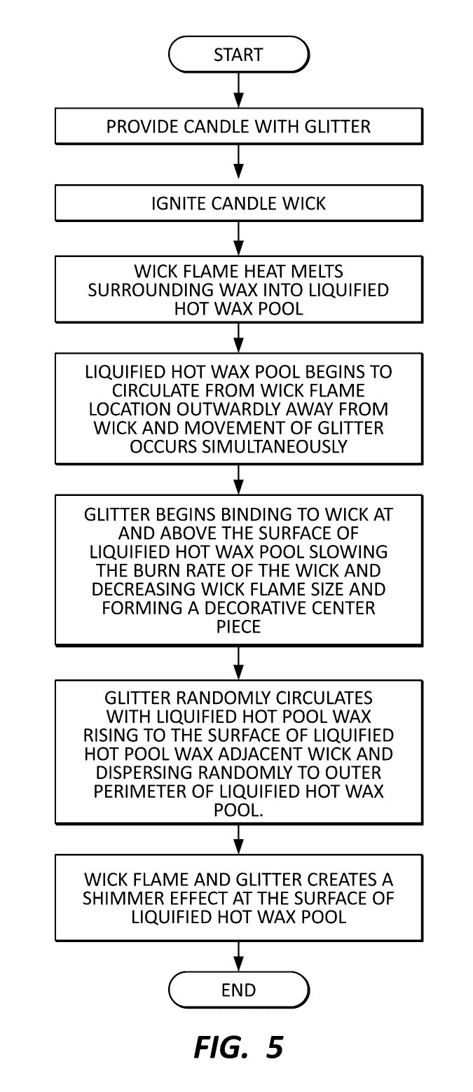

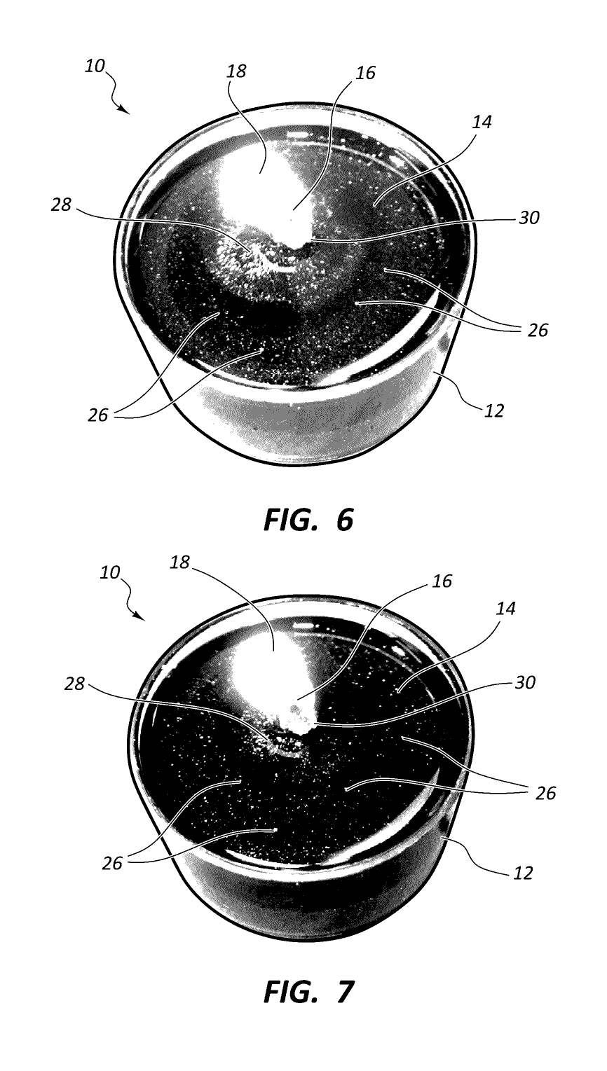

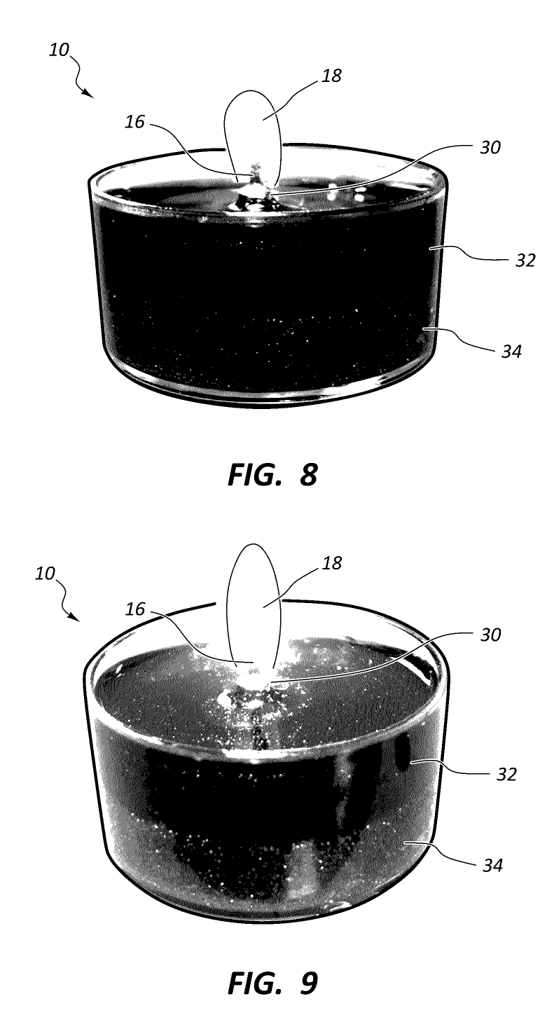

As a result of being mounted within the candle base mixture including reflective particles 26, the wick 16 has a longer burning life. When the wick 16 is lit, e.g., by match 20, light reflective particles 26 build up around wick 16, forming a particle mass 30 that may prolong the life of candle 10 by slowing the flow of wax 24 through wick 16 and also acts as a decorative centerpiece within candle 10. The light reflective particles 26 within candle 10 partially interfere with the ability of the wick to wick wax therethrough and may, if allowed to burn long enough, form a mass 30 of light reflective particles 26, e.g., glitter or fused glitter, about wick, as shown in FIG. 4C and FIGS. 6-9. The mass 30 remaining on wick 16 following the burning of candle 10 may be comprised of titanium dioxide and/or fused calcium aluminum borosilicate glass, for example. In another embodiment, the mass 30 remaining on wick 16 following the burning of candle 10 may be comprised of titanium dioxide and/or fused calcium aluminum borosilicate glass, silica, and possibly tin oxide, for example. Mass 30 is also a decorative centerpiece that provides an interesting and decorative appearance to candle 10 during the burning thereof, making it valuable to a consumer and observer.

The wax 24 of the present invention is candle wax, which may be soy wax, paraffin wax, a combination of soy wax and paraffin wax, beeswax, palm wax, and/or any type of wax suitable for burning as a candle. Blends of various waxes, e.g., soy and paraffin wax, may be employed. Wax wicks through the wick 16 as a flame burns on the wick 16. In one embodiment, the wick 16 of the present invention is comprised of a wick stem which extends through the candle base mixture connected to a metallic, or other non-combustible disc mounted at the bottom of the candle base mixture. Various types of wicks may be used in the present invention comprised of wicking material through which wax moves when drawn through the wick by a flame.

The light reflective particles 26 of the present invention may be inorganic light reflective particles, e.g., glitter, comprised of (i) at least one coloring agent, e.g., an oxide, such as titanium dioxide, and (ii) at least one reflecting agent (e.g., a glass), such as calcium aluminum borosilicate, and (iii) at least one anti-caking agent, such as silica. In one embodiment, the glitter further comprises tin oxide. Thus, in one embodiment, the glitter is comprised of titanium dioxide, calcium aluminum borosilicate, and silica and optionally, tin oxide. Those of skill in the art will appreciate that various other glitter compositions may be similarly suitable for use, and may include different components. At least one of the components of the glitter is light reflective, e.g., calcium aluminum borosilicate glass and/or an oxide so as to provide reflection of light from the flame of the candle, or other light (e.g., room light, particularly where a candle warmer is used, and no lighted wick may be present), so as to allow the user to better perceive the convective movement or flow of the molten wax, with the light reflective particles dispersed therein.

In one embodiment, the chemical nature of the glitter may be that calcium aluminum borosilicate is coated onto titanium dioxide (and possibly tin oxide) and the silica serves as an anti-caking agent, providing the desired reflective particles. In one embodiment, the chemical nature of the glitter material may be that calcium aluminum borosilicate is coated onto titanium dioxide and/or silica (and possibly tin oxide), providing the desired reflective particles. In another embodiment, the chemical nature of the glitter may be that the titanium dioxide and/or silica (and possibly tin oxide) are coated on the calcium aluminum borosilicate, providing the desired reflective particles.

In one embodiment, the glitter is an opaque pigment in the form of a white powder, which is added to the wax when the candle base mixture is mixed. In such an embodiment, the light reflective particles are glitter powder. The glitter may be produced commercially and in one embodiment of the present invention the glitter is comprised of a product known as RONASTAR NOBLE SPARKS, information for which is disclosed in provisional patent application Ser. No. 62/249,795, filed on Nov. 2, 2015, which is incorporated herein by reference. For example, the glitter may be comprised of particles having a length (or size, e.g., average particle size) of approximately 20 micrometers to approximately 200 micrometers, such as approximately 70 micrometers to approximately 90 micrometers, and wherein the glitter particles have a bulk density of approximately 3.5 to approximately 4.4 g/in³. It will thus be apparent that in at least some embodiments, the bulk density of the glitter particles may be less than the bulk density of the wax, whether solid or molten. For example, paraffin and other waxes may typically have a bulk density from about 0.6 g/cm³ (9 g/in³) to about 0.9 g/cm³ (13 g/in³). The relatively low bulk density of the glitter particles may be due to inefficient packing between the various particle components of the glitter (e.g., aided by a silica anti-caking agent, which may be fumed silica), resulting in relatively large spaces between adjacent particles in the bulk powder, as well as a relatively low density to individual particles themselves. Such relatively low density characteristics may aid the particles in being easily entrained and carried within the convective flow pattern of the molten wax within the inventive candles.

The particles may be generally spherical in shape, or may be flake shaped, or mixtures thereof (e.g., with some particles being of one shape, other particles being of other shapes).

By way of example, candle 10 may have a candle base mixture comprised of: (i) wax in an amount of about 99 percent to about 85 percent by weight and (ii) light reflective particles in an amount of about 1 percent to about 15 percent by weight. Candle 10 may further comprise fragrance in an amount of about 0 percent by weight to about 15 percent by weight.

In another embodiment of candle 10, the candle base mixture is comprised of: (i) wax in an amount of about 98.99 percent to about 80 percent by weight; (ii) light reflective particles in an amount of about 0.01 percent to about 10 percent by weight; and (iii) fragrance in an amount of about 1 percent to about 12 percent by weight.

In yet another embodiment of candle 10, the candle base mixture is comprised of: (i) wax in an amount of about 94.9 percent to about 88 percent by weight; (ii) light reflective particles in an amount of about 0.1 percent to about 2 percent by weight; and (iii) fragrance in an amount of about 5 percent to about 10 percent by weight.

In one specific formula of candle 10, the candle base mixture is comprised of: (i) wax in an amount of about 91.5 percent by weight; (ii) light reflective particles in an amount of about 0.5 percent by weight; and (iii) fragrance in an amount of about 8 percent by weight.

Examples of other formulas of the candle base mixture of candle 10 of the present invention include the following, where amounts are given in grams, or by weight percent:

Sample Candle Base Mixture Formula 1

| | |
|---|---|
| IGI 6006A Wax | 91.5 |
| Cinnamon Sugar Fragrance | 8 |
| (Orchidia - ORC1300744) | |
| RONASTAR Noble Sparks | 0.5 |

Sample Candle Base Mixture Formula 2

| | |
|---|---|
| IGI 6006A Wax | 91.314 |
| Cranberry Spice Fragrance | 8 |
| (Orchidia - ORC0702229) | |
| RONASTAR Noble Sparks | 0.5 |
| Red/Dark Pink Liquid Dye | 0.186 |

Sample Candle Base Mixture Formula 3

| | |
|---|---|
| IGI 6006A Wax | 91.328 |
| Frosted Pinecone Fragrance | 8 |
| (Flavor & Fragrance - 128P54) | |
| RONASTAR Noble Sparks | 0.5 |
| Apple Green/Melon Liquid Dye | 0.172 |

Sample Candle Base Mixture Formula 4

| | |
|---|---|
| IGI 6006A Wax | 91.482 |
| Plum Brandy Fragrance | 8 |
| (Flavor & Fragrance - 128P56) | |
| RONASTAR Noble Sparks | 0.5 |
| Blue/Sky Blue Liquid Dye | 0.018 |

The candle base mixture can be mixed in a variety of different manners. For example, in one embodiment, the mixing instructions are as follows:

Example of Mixing instructions:

1—Measure the wax base and place it in the kettle;
2—Heat the kettle to 140 degrees Fahrenheit;
3—When the wax melts completely, then add oil fragrance with mixing;
4—Add the RonaStar Noble Sparks glitter with mixing;
5—Add Dye to the generate the desired color of candle;
6—Pour into the containers (with the wicks mounted therein) and let candles cool down to room temperature and harden.

An example of making candle 10 will now be discussed below.

### Candle Making Method Example 1

1) 91.5 pounds of IGI 6006A Soy Wax is placed into a kettle and is heated to 140 degrees Fahrenheit;
2) After the wax melts completely, 8 pounds of Cinnamon Sugar Fragrance (Orchida—ORC1300744) is added to the melted wax and mixed into the wax;
3) 0.5 pounds of RonaStar Noble Sparks glitter is added to the wax/fragrance mixture and mixed;
4) The resulting candle base mixture is then poured into 100 containers having wicks therein, after which the candle base mixture is allowed to cool and harden, forming 100 candles;
5) One of the wicks of the candles is lit with a match, generating a flame.
6) As wax melts within the candle, molten liquid is formed near the wick in the central portion of the candle moving outward away from the wick. The RONASTAR NOBLE SPARKS glitter highlights the flowing molten liquid, creating the aesthetic appearance of lava flow because of the reflection of the flame onto the RONASTAR NOBLE SPARKS glitter within the wax.

### Candle Making Method Example 2

1) 91.314 pounds of IGI 6006A Soy Wax is placed into a kettle and is heated to 140 degrees Fahrenheit;
2) After the wax melts completely, 8 pounds of Cranberry Spice Fragrance (Orchidia—ORC0702229) is added to the melted wax and mixed into the wax, forming a fragrance/wax mixture
3) 0.5 pounds of RONASTAR Noble Sparks glitter is added and mixed;
4) Red/Dark Pink Liquid Dye in an amount of 0.186 pounds is added and mixed, forming a candle base mixture.
5) The candle base mixture is then poured into 100 containers having wicks therein, after which the candle base mixture is allowed to cool and harden, forming 100 candles;
6) One of the wicks of the candles is lit with a match, generating a flame.
7) As wax melts within the candle, molten liquid is formed near the wick in the central portion of the candle moving outward away from the wick. The RONASTAR NOBLE SPARKS glitter highlights the flowing molten liquid, creating the aesthetic appearance of lava flow because of the reflection of the flame onto the RONASTAR NOBLE SPARKS glitter within the wax.
8) The candle comprising the glitter burns longer than candles having the same or similar materials without glitter.

Although described principally with addition of any fragrance prior to the addition of the glitter, such order may be reversed. The order of addition may not be particularly important, so that the various components may be added in any order, or simultaneously.

Examples of possible ranges of ingredients of the candle base mixture will now be disclosed below.

### Examples of Candle Base Mixture

TABLE 1

| | Embodiment 1 | Embodiment 2 | Embodiment 3 | Embodiment 4 | Embodiment 5 |
|---|---|---|---|---|---|
| | Percent (wt) | Percent (wt) | Percent (wt) | Percent (wt) | Percent (wt) |
| Wax | about 99.999 | about 99.99 to | about 99.9 to | about 99.7 | about 99.5 |
| | to about 85 | about 90 | about 98 | to about 99 | |
| Glitter | about 0.001 | about 0.01 to | about 0.1 to | about 0.3 to | about 0.5 |
| | to about 15 | about 10 | about 2 | about 1 | |

TABLE 2

| | Embodiment 1 | Embodiment 2 | Embodiment 3 | Embodiment 4 | Embodiment 5 |
|---|---|---|---|---|---|
| | Percent (wt) | Percent (wt) | Percent (wt) | Percent (wt) | Percent (wt) |
| Wax | about 99.999 | about 98.99 | about 94.9 to | about 94.7 | about 91.5 |
| | to about 85 | to about 80 | about 88 | to about 89 | |
| Glitter | about 0.001 | about 0.01 to | about 0.1 to | about 0.3 to | about 0.5 |
| | to about 15 | about 10 | about 2 | about 1 | |
| Fragrance | 0 to about 15 | about 1 to | about 5 to | about 5 to | about 8 |
| | | about 12 | about 10 | about 10 | |

TABLE 3

| | Embodiment 1 | Embodiment 2 | Embodiment 3 | Embodiment 4 | Embodiment 5 |
|---|---|---|---|---|---|
| | Percent (wt) | Percent (wt) | Percent (wt) | Percent (wt) | Percent (wt) |
| Wax | about 99.999 | about 98.98 | about 94.8 to | about 94.6 | about 91.3 |
| | to about 85 | to about 80 | about 88 | to about 89 | |
| Glitter | about 0.001 | about 0.01 to | about 0.1 to | about 0.3 to | about 0.5 |
| | to about 15 | about 10 | about 2 | about 1 | |
| Fragrance | 0 to about 15 | about 1 to | about 5 to | about 5 to | about 8 |
| | | about 12 | about 10 | about 10 | |
| Dye | 0 to about 10 | about 0.01 to | about 0.1 to | 0.1 to 1 | about 0.2 |
| | | about 2 | about 1 | | |

In one embodiment, a blend of soy wax and paraffin wax has a melting point of 124° F. and has the following physical properties:

### Physical Properties of Blend of Paraffin Wax and Soy Wax

| | ASTM | SPECIFICATIONS | | |
|---|---|---|---|---|
| TEST METHODS | METHOD | Minimum | Maximum | TYPICAL |
| Melt Point ° F. (° C.) | _{zc}D 87 | 120 (48.9) | 129 (53.9) | 124 (51.1) |
| Kinematic | _{zd}D 445 | 2.9 | 5.4 | 4.0 |
| Viscosity, cSt @ | | | | |
| 212° F. (100° C.) | | | | |
| Saybolt Color | _{zo}D 6045 | +15 | — | +20 |
| Needle Penetration, | _{zr}D 1321 | — | 50 | 30 |
| dmm @ | | | | |
| 77° F. (25° C.) | | | | |
| API Gravity | _{zz}D 287 | — | — | 41.5 |

However, various types of wax, glitter, fragrance and/or dye are available for use in the present invention. In an embodiment, soy wax may be blended with another wax (e.g., paraffin wax) to form the wax of the present invention.

It will be appreciated that the glitter may be present within the candle wax base in an amount from about 0.001% to about 15%, from about 0.01% to about 10%, from about 0.1% to about 2%, from about 0.3% to about 1%, or about 0.5% by weight, independent of the amounts of any other components included in the candle wax base.

It will be appreciated that a fragrance may be present within the candle wax base in an amount from 0% to about 15%, from about 1% to about 12%, from about 5% to about 10%, or about 8% by weight, independent of the amounts of any other components included in the candle wax base.

It will be appreciated that a dye may be present within the candle wax base in an amount from 0% to about 10%, from about 0.01% to about 2%, from about 0.1% to about 1%, or about 0.2% by weight, independent of the amounts of any other components included in the candle wax base.

It will be appreciated that the wax may simply comprise the balance of the candle wax base (e.g., 100%−weight percent glitter−weight percent fragrance−weight percent dye). By way of example, the wax may be present within the candle wax base in an amount from about 80% to about 99.999%, from about 85% to about 98.99%, from about 88% to about 94.9%, from about 89% to about 94.7%, or about 91.5% by weight.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A candle with shimmering properties, comprising:
wax; and
light reflective particles dispersed throughout the wax, such that upon lighting the candle with a flame or heating the wax with a candle warmer, at least a portion of the candle melts from a solid state to a liquid state, forming a pool of molten liquid in which the liquid moves, and wherein the light reflective particles highlight the movement of the liquid, such that the movement of the liquid is visible to an observer.

2. A candle as recited in claim 1, wherein the light reflective particles are inorganic light reflective particles comprising glass.

3. A candle as recited in claim 1, wherein the light reflective particles are comprised of an oxide, at least one reflecting agent, and an anti-caking agent.

4. A candle as recited in claim 3, wherein the oxide is titanium dioxide and the anti-caking agent is silica and the reflecting agent is calcium aluminum borosilicate.

5. A candle as recited in claim 1, wherein the light reflective particles are comprised of an opaque pigment.

6. A candle as recited in claim 1, wherein the light reflective particles are comprised of glitter.

7. A candle as recited in claim 6, wherein the glitter is comprised of a coloring agent, a reflecting agent, and an anti-caking agent.

8. A candle as recited in claim 7, wherein the glitter is comprised of titanium dioxide, calcium aluminum borosilicate, and silica.

9. A candle as recited in claim 1, further comprising a container, wherein a wick is mounted within the mixture of wax and particles and wherein the wax/particle mixture is positioned within the container.

10. A candle as recited in claim 1, wherein the light reflective particles have a length of approximately 20 micrometers to approximately 200 micrometers and wherein the light reflective particles have density of approximately 3.5 to approximately 4.4 g/in³ and
wherein the wax and reflective particles are mixed in a mixture that is comprised of: (i) wax in an amount of about 99.999 percent to about 85 percent by weight and (ii) light reflective particles in an amount of about 0.001 percent to about 15 percent by weight.

11. A candle with shimmering properties, comprising:
a candle base mixture, comprising:
wax; and
inorganic light reflective particles dispersed throughout the wax,
a wick mounted within the candle base mixture; and
a container for containing the candle base mixture, wherein, upon lighting the wick with a flame, at least a portion of the candle base mixture melts from a solid state to a liquid state, forming a pool of molten liquid in which the liquid moves, and wherein the light reflective particles highlight the movement of the liquid, such that the movement of the liquid is visible to an observer.

12. A candle as recited in claim 11, wherein the candle base mixture is comprised of: (i) wax in an amount of about 98.99 percent to about 80 percent by weight; (ii) light reflective particles in an amount of about 0.01 percent to about 10 percent by weight; and (iii) fragrance in an amount of about 1 percent to about 12 percent by weight.

13. A candle as recited in claim 11, wherein the light reflective particles are glitter.

14. A candle as recited in claim 13, wherein the glitter is comprised of titanium dioxide, calcium aluminum borosilicate, and silica.

15. A candle as recited in claim 11, wherein the inorganic light reflective particles are amassed about the wick, decreasing the amount of wax flowing to the wick, thereby decreasing the size of the flame on the wick.

16. A candle with a slow burning wick, comprising:
a candle base mixture, comprising:
wax; and
inorganic particles dispersed throughout the wax, such that upon lighting the candle base mixture with a flame, at least a portion of the candle base mixture melts from a solid state to a liquid state, forming a pool of molten liquid in which the liquid moves;
a wick mounted within the candle base mixture; and
a container for containing the candle base mixture,
wherein the inorganic particles are amassed about the wick, forming a decorative centerpiece surrounding the wick.

17. A candle as recited in claim 16, wherein inorganic particles amassed about the wick are above the surface of the liquid candle base mixture and wherein inorganic particles amassed about the wick adhere to the wick.

18. A candle as recited in claim 16 wherein the inorganic particles are comprised of glitter.

19. A method of making a candle with shimmering properties, comprising:
providing wax; and
mixing the wax with light reflective particles dispersed throughout the wax, such that upon lighting the candle with a flame or heating the wax with a candle warmer, at least a portion of the candle melts from a solid state to a liquid state, forming a pool of molten liquid in which the liquid moves, and wherein the light reflective particles highlight the movement of the liquid, such that the movement of the liquid is visible to an observer.

20. A method as recited in claim 19, further comprising placing the wax/reflective particles mixture into a container, mounting a wick within the mixture of wax/reflective particles, and allowing the wax/reflective particles mixture to cool and harden,
wherein the light reflective particles are comprised of glitter, wherein the glitter is comprised of an oxide, at least one reflecting agent, and an anti-caking agent, and
wherein the wax and reflective particles are mixed in a mixture that is comprised of: (i) wax in an amount of about 99.999 percent to about 85 percent by weight and (ii) light reflective particles in an amount of about 0.001 percent to about 15 percent by weight,
wherein the oxide is titanium dioxide and the anti-caking agent is silica and the reflecting agent is calcium aluminum borosilicate, and wherein
the light reflective particles have a length of approximately 20 micrometers to approximately 200 micrometers and wherein the light reflective particles have density of approximately 3.5 to approximately 4.4 g/in³.
